(19) United States
(12) Patent Application Publication
(10) Pub. No.: US 2026/0321280 A1
(43) Pub. Date: Oct. 15, 2026

(54) WEARABLE DEVICE FOR DETECTING SPEECH, AND CONTROL METHOD THEREFOR

(71) Applicant: SAMSUNG ELECTRONICS CO., LTD., Suwon-si (KR)

(72) Inventors: Minseung KIM, Suwon-si (KR); Bosung KIM, Suwon-si (KR); Sangeun KIM, Suwon-si (KR); Geeyeun KIM, Suwon-si (KR); Hangil MOON, Suwon-si (KR); Kyoungho BANG, Suwon-si (KR); Soonho BAEK, Suwon-si (KR); Gunwoo LEE, Suwon-si (KR)

(73) Assignee: SAMSUNG ELECTRONICS CO., LTD., Suwon-si (KR)

(21) Appl. No.: 19/699,780

(22) Filed: Jun. 5, 2026

Related U.S. Application Data
(63) Continuation of application No. PCT/KR2024/019245, filed on Nov. 29, 2024.

(30) Foreign Application Priority Data
Dec. 5, 2023 (KR) 10-2023-0174868
Dec. 29, 2023 (KR) 10-2023-0196058

(51) Int. Cl. G10L 25/84; G10L 25/18; G10L 25/30; H04R 29/00

(52) U.S. Cl. CPC G10L 25/84; G10L 25/18; G10L 25/30; H04R 29/005; H04R 2420/07

(57) ABSTRACT

A wearable device includes: a first microphone disposed at a first position; a second microphone disposed at a second position different from the first position; at least one processor and memory storing instructions, wherein the instructions, when executed by the at least one processor individually or collectively, cause the wearable device to: obtain a magnitude feature of a first audio signal obtained by the first microphone, obtain an energy ratio of the first audio signal to a second audio signal obtained by the second microphone, and determine, using a trained artificial neural network, whether the first audio signal or the second audio signal includes a voice based on the magnitude feature and the energy ratio.

### CROSS-REFERENCE TO RELATED APPLICATION(S)

This application is a continuation of International Application No. PCT/KR2024/019245 filed on Nov. 29, 2024, which is based on claims priority to Korean Patent Application No. 10-2023-0174868, filed on Dec. 5, 2023, and Korean Patent Application No. 10-2023-0196058, filed Dec. 29, 2023, in the Ministry of Intellectual Property Office, Republic of Korea, the disclosures of which are incorporated by reference herein in their entireties.

### BACKGROUND

### 1. Field

The disclosure relates to a wearable device for detecting voice and a method for controlling the same.

### 2. Description of Related Art

Wearable devices, such as wireless earphones (for example, Samsung® Buds®), now offer an increasingly diverse range of services and additional functions. In order to enhance the utility value of these electronic devices and satisfy the demands of various users, communication service providers and electronic device manufacturers provide various functions and competitively develop electronic devices to differentiate themselves from other companies. As a result, the various functions provided through wearable devices are becoming increasingly advanced.

In the related art, voice detection techniques primarily rely on rule-based approaches that extract hand-crafted features and compare them with thresholds. However, in environments in which the power of voice is weak or noise is relatively strong, that is, in low signal-to-noise ratio (SNR) conditions, the performance of such simply designed voice detectors tends to degrade sharply. In particular, “energy,” which is one of the most important voice detection features, is known to cause a high false-alarm rate when the signal characteristics of noise are non-stationary. In the case of voice detection used as a preprocessing step for various applications, such as communication solutions using wireless earphones, more careful consideration is required. Unlike a mobile terminal in which a user's voice is directly transmitted to a microphone at a short distance, wireless earphones may be exposed to more unfavorable SNR conditions due to a relatively longer distance from the mouth. In addition, since the distance between a speaker and a microphone is short, the device is exposed to high-energy echo, and various noises such as wind noise may act as factors that make voice detection difficult in the wearable device.

### SUMMARY

One or more embodiments of the disclosure provide a wearable device configured to determine whether voice is included in an obtained audio signal based on a magnitude spectrum (in other words, a magnitude feature or an energy spectrum) and an energy ratio of an audio signal obtained by a microphone of the wearable device, and to perform a voice detection function or operation robust to noise.

One or more embodiments of the disclosure provide a wearable device configured to determine whether the microphone is shielded and to compute a magnitude spectrum and an energy ratio based on a result of the determination, thereby improving accuracy of voice detection compared to related art techniques.

According to an aspect of the disclosure, there is provided a wearable device including: a first microphone disposed at a first position; a second microphone disposed at a second position different from the first position; at least one processor and memory storing instructions, wherein the instructions, when executed by the at least one processor individually or collectively, cause the wearable device to: obtain a magnitude feature of a first audio signal obtained by the first microphone, obtain an energy ratio of the first audio signal to a second audio signal obtained by the second microphone, and determine, using a trained artificial neural network, whether the first audio signal or the second audio signal includes a voice based on the magnitude feature and the energy ratio.

According to an aspect of the disclosure, there is provided a method including: obtaining a magnitude feature of a first audio signal obtained by a first microphone of a wearable device; obtaining an energy ratio of the first audio signal to a second audio signal obtained by a second microphone of the wearable device; and determining, using a trained artificial neural network, whether the first audio signal or the second audio signal includes a voice based on the magnitude feature and the energy ratio.

According to an aspect of the disclosure, there is provided a non-transitory computer-readable recording medium storing instructions that, when executed by a processor of a wearable device, cause the wearable device to: obtain a magnitude feature of a first audio signal obtained by a first microphone of a wearable device; obtain an energy ratio of the first audio signal to a second audio signal obtained by a second microphone of the wearable device; and determine, using a trained artificial neural network, whether the first audio signal or the second audio signal includes a voice based on the magnitude feature and the energy ratio.

The wearable device according to an embodiment of the disclosure may determine whether voice is included in an audio signal obtained by a microphone of the wearable device based on a magnitude spectrum (in other words, a magnitude feature or an energy spectrum) of the audio signal and an energy ratio, thereby providing a wearable device capable of performing a voice detection function or operation robust to noise.

The wearable device according to an embodiment of the disclosure may determine whether the microphone is shielded and compute the magnitude spectrum and the energy ratio based on the determination result, thereby providing a wearable device having improved accuracy of voice detection compared to related art techniques.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to various embodiments of the disclosure;

FIG. 2 is an example diagram for describing a connection relationship between an electronic device and a wearable device according to an embodiment of the disclosure;

FIG. 3 is an example diagram for describing a configuration of a first wearable device according to an embodiment of the disclosure;

FIG. 4A is an example diagram for describing a function or operation of a wearable device performing voice detection based on features of audio signals obtained through microphones of the wearable device according to an embodiment of the disclosure;

FIG. 4B is an example diagram for describing a function or operation of a wearable device training an artificial neural network according to an embodiment of the disclosure;

FIG. 5 is an example diagram for describing a function or operation of a wearable device performing voice detection through a trained artificial neural network based on magnitude features and energy ratio features of audio signals according to an embodiment of the disclosure;

FIG. 6 is an example diagram for describing a function or operation of a wearable device calculating an energy ratio based on whether microphones of the wearable device are shielded according to an embodiment of the disclosure;

FIG. 7 is an example diagram for describing a function or operation of a wearable device processing magnitude features and energy ratio features input to a trained artificial neural network according to an embodiment of the disclosure; and

FIG. 8 is an example diagram for describing a function or operation of a wearable device determining a computation ratio of a trained artificial neural network based on a signal-to-noise ratio of an audio signal input through a microphone of the wearable device according to an embodiment of the disclosure.

### DETAILED DESCRIPTION

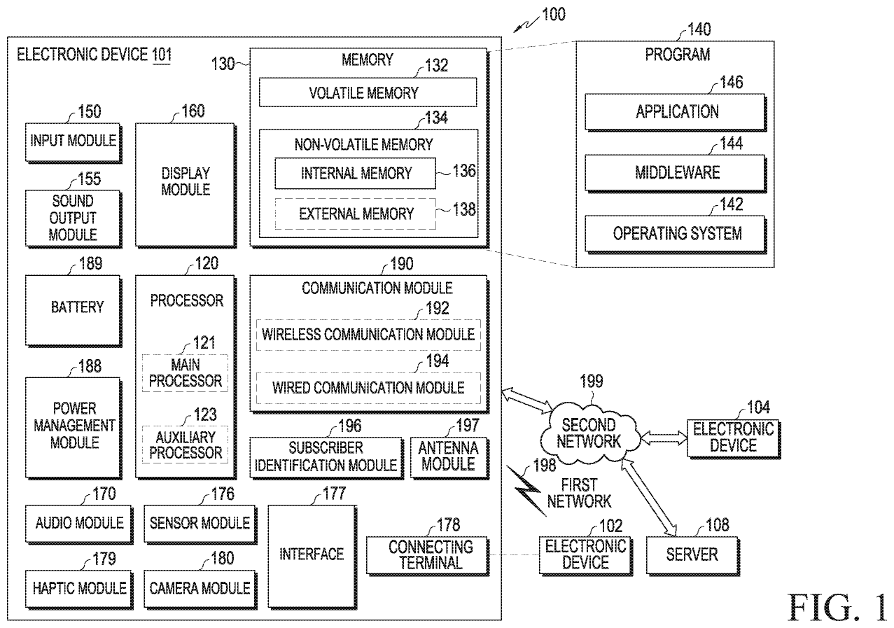

FIG. 1 is a block diagram illustrating an electronic device 101 in a network environment 100 according to an embodiment.

Referring to FIG. 1, the electronic device 101 in the network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment, the electronic device 101 may communicate with the external electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least portion of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as portion of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as portion of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as portion of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or via an external electronic device (e.g., electronic device 102, such as a speaker or a headphone) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least portion of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other portions (e.g., radio frequency integrated circuit (RFIC)) than the radiator may be further formed as portion of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least portion of the function or the service. The one or more external electronic devices receiving the request may perform the at least portion of the function or the service requested, or an additional function or an additional service related to the request, and transfer an outcome of the performing to the electronic device 101. The electronic device 101 may provide the outcome, with or without further processing of the outcome, as at least portion of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

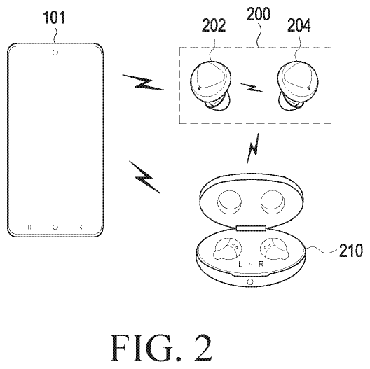

FIG. 2 is an example diagram for describing a connection relationship between an electronic device 101 and a wearable device 200 (e.g., the electronic device 101) according to an embodiment of the disclosure.

Referring to FIG. 2, the electronic device 101 according to an embodiment of the disclosure may be wirelessly connected to the wearable device 200. The electronic device 101 according to an embodiment of the disclosure may include a smartphone as illustrated in FIG. 2, but may also be implemented as various types of devices (e.g., a notebook computer including a standard notebook, an ultrabook, a netbook, and a tabbook, a laptop computer, a tablet computer, or a desktop computer).

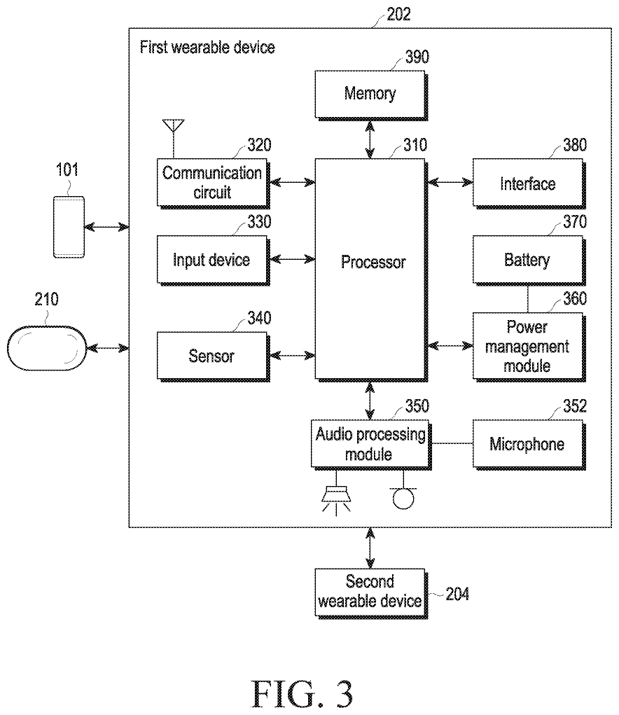

The wearable device 200 according to an embodiment of the disclosure may be implemented as wireless earphones as illustrated in FIG. 2, but may also be implemented as various types of devices (e.g., a smartwatch, a head-mounted display device, or devices for measuring biosignals (e.g., an electrocardiogram patch)). According to an embodiment of the disclosure, the wearable device 200 may include a pair of devices (e.g., a first wearable device 202 and a second wearable device 204). According to an embodiment of the disclosure, the pair of devices (e.g., the first wearable device 202 and the second wearable device 204) may be implemented to include the same or similar configurations (e.g., configurations described with reference to FIG. 3).

According to an embodiment of the disclosure, the electronic device 101 and the wearable device 200 may establish a communication connection with each other and may transmit and/or receive data to and/or from each other. For example, the electronic device 101 and the wearable device 200 may establish a communication connection with each other by using device-to-device (D2D) communication such as Wi-Fi Direct or Bluetooth (e.g., by using a communication circuit supporting the corresponding communication scheme), but embodiments of the disclosure are not limited thereto and various types of communication (e.g., a communication scheme such as Wi-Fi using an access point (AP), a cellular communication scheme using a base station, or a wired communication scheme) may also be used.

According to an embodiment of the disclosure, when the wearable device 200 is wireless earphones, the electronic device 101 may establish a communication connection with one of a pair of devices (e.g., a first wearable device 202 and a second wearable device 204), for example a main earphone, or may establish a communication connection with both of the pair of devices (e.g., the first wearable device 202 and the second wearable device 204). According to an embodiment of the disclosure, the electronic device 101 may communicate with the other device (e.g., a sub earphone) through one of the pair of devices (e.g., the first wearable device 202 and the second wearable device 204), for example, a main earphone.

According to an embodiment of the disclosure, when the wearable device 200 is wireless earphones, the pair of devices (e.g., the first wearable device 202 and the second wearable device 204) may establish a communication connection with each other and may transmit and/or receive data (e.g., audio data and/or control data) to and/or from each other. The communication connection may be established by using device-to-device (D2D) communication such as Wi-Fi Direct or Bluetooth (e.g., by using a communication circuit supporting the corresponding communication scheme), but is not limited thereto.

According to an embodiment of the disclosure, one of a pair of devices (e.g., a first wearable device 202 and a second wearable device 204) may become a main device (or a primary device or a main device), and the other device may become a sub device (or a secondary device), and the main device may transmit data to the sub device. For example, when the pair of devices (e.g., the first wearable device 202 and the second wearable device 204) establish a communication connection with each other, one of the pair of devices (e.g., the first wearable device 202 and the second wearable device 204) may be randomly selected as the main device, and the other device may be selected as the sub device.

According to an embodiment of the disclosure, when the pair of devices (e.g., the first wearable device 202 and the second wearable device 204) establish a communication connection with each other, the device on which wearing is first detected (e.g., a value indicating wearing is detected using a sensor for wearing detection (e.g., a proximity sensor, a touch sensor, a 6-axis tilt sensor, or a 9-axis tilt sensor)) may be selected as the main device, and the other device may be selected as the sub device. According to an embodiment of the disclosure, the main device may transmit data received from the electronic device 101 to the sub device. For example, the first wearable device 202, which is the main device, may output audio through a speaker based on audio data received from the electronic device 101, and may also transmit the audio data to the second wearable device 204, which is the sub device. In an embodiment, the sub device may receive audio data transmitted from the electronic device 101 to the main device by sniffing based on connection information provided by the main device.

According to an embodiment of the disclosure, the first wearable device 202, which is the main device, may transmit data (e.g., audio data or control data) received from the second wearable device 204, which is the sub device, to the electronic device 101. For example, when a touch event occurs at the second wearable device 204, which is the sub device, control data including information about the occurred touch event may be transmitted to the electronic device 101 by the first wearable device 202, which is the main device. However, according to an embodiment of the disclosure, the sub device and the electronic device 101 may establish a communication connection with each other, and accordingly, transmission and/or reception of data may be directly performed between the sub device and the electronic device 101.

According to an embodiment of the disclosure, the first wearable device 202 and the second wearable device 204 may be connected, via wired and/or wireless communication, to an electronic device 210 having one or more storage spaces having sizes and shapes corresponding to the first wearable device 202 and the second wearable device 204. In an embodiment, the electronic device 210 may be an earphone case or a cradle device configured to store and charge the first wearable device 202 and the second wearable device 204. In an embodiment, the electronic device 210 may establish a communication connection with the first wearable device 202 and the second wearable device 204 and may transmit and/or receive data therebetween. According to an embodiment of the disclosure, the electronic device 210 may establish a communication connection with the electronic device 101 and may transmit and/or receive data to and/or from the electronic device 101. For example, the electronic device 210 may transmit, to the electronic device 101, information on a state (e.g., whether the devices are operating) of the first wearable device 202 and the second wearable device 204 and/or a state of the electronic device 210 (e.g., whether a cover is opened or closed, or whether the first wearable device 202 and/or the second wearable device 204 are accommodated).

Hereinafter, for convenience of description, a case in which the wearable device 200 is a pair of wearable devices 202 and 204 will be described; however, the following description may be substantially equally applied to various types of wearable devices 200 (e.g., a smartwatch, a head-mounted display device, or devices for measuring biosignals).

FIG. 3 is an example diagram for describing a configuration of a first wearable device 202 according to an embodiment of the disclosure.

According to an embodiment of the disclosure, the first wearable device 202 may be a main earbud connectable to the electronic device 101 illustrated in FIG. 1 (e.g., a smartphone), and the second wearable device 204 may be a sub earbud connectable to the main earbud.

According to an embodiment of the disclosure, the first wearable device 202 may include at least one component that is the same as or similar to at least one of components (e.g., modules) of the electronic device 101 illustrated in FIG. 1. According to an embodiment of the disclosure, the first wearable device 202 may include at least one of a communication circuit 320 (e.g., the communication module 190 of FIG. 1), an input device 330 (e.g., the input module 150 of FIG. 1), a sensor 340 (e.g., the sensor module 176 of FIG. 1), an audio processing module 350 (e.g., the audio module 170 of FIG. 1), memory 390 (e.g., the memory 130 of FIG. 1), a power management module 360 (e.g., the power management module 188 of FIG. 1), a battery 370 (e.g., the battery 189 of FIG. 1), an interface 380 (e.g., the interface 177 of FIG. 1), and at least one processor 310 (e.g., the processor 120 of FIG. 1).

According to an embodiment of the disclosure, the communication circuit 320 may include at least one of a wireless communication module (e.g., a Bluetooth communication module, a cellular communication module, a Wi-Fi (wireless fidelity) communication module, a near field communication (NFC) communication module, or a global navigation satellite system (GNSS) communication module) or a wired communication module (e.g., a local area network (LAN) communication module or a power line communication (PLC) communication module). According to an embodiment of the disclosure, the communication circuit 320 may, by using the at least one communication module included therein, directly or indirectly communicate, through a first network (e.g., the first network 198 of FIG. 1), with at least one of the electronic device 101 (e.g., a smartphone), a case device 210 (e.g., a charging device such as a cradle), or the second wearable device 204 (e.g., a sub wearable device). According to an embodiment of the disclosure, the second wearable device 204 may be a component of an ear wearable device 200 configured as a pair with the first wearable device 202. According to an embodiment of the disclosure, the communication circuit 320 may operate independently of the processor 310 and may include one or more communication processors supporting wired or wireless communication. According to an embodiment of the disclosure, the communication circuit 320 may be connected to one or more antennas capable of transmitting a signal or information to another electronic device (e.g., at least one of the electronic device 101, the case device 210, or the second wearable device 204) or receiving a signal or information from another electronic device. According to an embodiment of the disclosure, at least one antenna suitable for a communication scheme used in a communication network such as the first network (e.g., the first network 198 of FIG. 1) or a second network (e.g., the second network 199 of FIG. 2) may be selected by the communication circuit 320, for example, from among the plurality of antennas. A signal or information may be transmitted or received between the communication circuit 320 and another electronic device through the selected at least one antenna.

According to an embodiment of the disclosure, the input device 330 may be configured to generate various input signals that may be used for an operation of the first wearable device 202. According to an embodiment of the disclosure, the input device 330 may include at least one of a touch pad, a touch panel, or a button. According to an embodiment of the disclosure, the touch pad may recognize a touch input, for example, in at least one manner among a capacitive manner, a resistive manner, an infrared manner, or an ultrasonic manner. According to an embodiment of the disclosure, when a capacitive touch pad is provided, physical contact or proximity recognition may be possible. The touch pad may further include a tactile layer. The touch pad including the tactile layer may provide a tactile response to a user. The button may include, for example, a physical button or an optical key.

According to an embodiment of the disclosure, the input device 330 may generate a user input related to turning on or off the first wearable device 202. According to an embodiment of the disclosure, the input device 330 may receive a user input for a communication connection between the first wearable device 202 and the second wearable device 204. According to an embodiment of the disclosure, the input device 330 may receive a user input related to audio data (or audio content). For example, the user input may be related to functions of starting playback, pausing playback, stopping playback, adjusting a playback speed, adjusting a playback volume, or muting audio data. According to an embodiment of the disclosure, an operation of the first wearable device 202 may be controlled by various gestures of a user, such as tapping a surface on which a touch pad is disposed or swiping up or down. According to an embodiment of the disclosure, the input device 330 may receive a user input for initiating pairing between the first wearable device 202 and the electronic device 101. For example, in response to the user input, the processor 310 may operate the first wearable device 202 in a pairing mode (e.g., an inquiry scan mode or a BLE advertising scan mode).

According to various embodiments, the sensor 340 may identify a position or an operating state of the first wearable device 202 or identify whether a cover of the case device 210 is in an open state or a closed state. According to an embodiment of the disclosure, the sensor 340 may convert measured or identified information into an electrical signal. According to an embodiment of the disclosure, the sensor 340 may include, for example, at least one of a magnetic sensor, an acceleration sensor, a gyro sensor, a geomagnetic sensor, a proximity sensor, a gesture sensor, a grip sensor, or a biometric sensor. In an embodiment, the sensor 340 may further include an optical sensor. The optical sensor may include a light emitting unit (e.g., a light emitting diode (LED)) configured to output light of at least one wavelength band. The optical sensor may include a light receiving unit (e.g., a photodiode) configured to receive light of one or more wavelength bands scattered or reflected from an object and generate an electrical signal.

According to an embodiment of the disclosure, the audio processing module 350 may support an audio data collection function and may reproduce collected audio data. According to an embodiment of the disclosure, the audio processing module 350 may include an audio decoder and a digital-to-analog (D/A) converter. According to an embodiment of the disclosure, the audio decoder may convert audio data stored in the memory 390 or received from the electronic device 101 through the communication circuit 320 into a digital audio signal. According to an embodiment of the disclosure, the D/A converter may convert the digital audio signal converted by the audio decoder into an analog audio signal. According to an embodiment of the disclosure, the audio decoder may convert audio data received from the electronic device 101 through the communication circuit 320 and stored in the memory 390 into a digital audio signal. According to an embodiment of the disclosure, a speaker may output the analog audio signal converted by the D/A converter. According to an embodiment of the disclosure, the audio processing module 350 may include an analog-to-digital (A/D) converter. The A/D converter may convert an analog voice signal received through a microphone into a digital voice signal. According to an embodiment of the disclosure, the audio processing module 350 may reproduce various audio data set for an operation of the first wearable device 202. For example, the processor 310 may detect, through the sensor 340, a state in which the first wearable device 202 is attached to a user's ear or detached from the user's ear, and may be configured to reproduce audio data related to a sound effect or a notification sound through the audio processing module 350. According to an embodiment of the disclosure, output of the sound effect or the notification sound may be omitted according to a user setting or an intention of a designer.

According to an embodiment of the disclosure, the wearable device (e.g., the first wearable device 202) may include at least one microphone 352. According to an embodiment of the disclosure, the wearable device (e.g., the first wearable device 202) may include an internal microphone (e.g., a first microphone 510) disposed at a first position of the wearable device (e.g., the first wearable device 202), the first external microphone (e.g., the second microphone 520) disposed at a second position of the wearable device (e.g., the first wearable device 202), and/or a second external microphone (e.g., a third microphone 530) disposed at a third position of the wearable device (e.g., the first wearable device 202). According to an embodiment of the disclosure, the internal microphone (e.g., the first microphone 510) may be disposed at a position closer to a user's body than other microphones when the first wearable device 202 is worn on the user's ear. According to an embodiment of the disclosure, a first external microphone (e.g., a second microphone 520) may be predefined or may be selected by a user. According to an embodiment of the disclosure, the wearable device 200 may include three or more external microphones.

According to an embodiment of the disclosure, the memory 390 may store various data used by at least one component (e.g., the processor 310 or the sensor 340) of the first wearable device 202. According to an embodiment of the disclosure, the data may include, for example, input data or output data for software and instructions related thereto. According to an embodiment, the data may include audio data received from the electronic device 101, information on a cover state (e.g., an open state or a closed state) of the case device 210, location information of the second wearable device 204 received from the case device 210 or the second wearable device 204, or role information and information on at least one parameter required for a connection with the second wearable device 204. The memory 390 may include a volatile memory or a non-volatile memory.

According to an embodiment of the disclosure, the power management module 360 may manage power supplied to the first wearable device 202. According to an embodiment of the disclosure, the power management module 360 may be implemented as, for example, at least a part of a power management integrated circuit (PMIC). According to an embodiment of the disclosure, the power management module 360 may include a battery charging module. According to an embodiment of the disclosure, when another electronic device (e.g., the electronic device 101, the case device 210, or the second wearable device 204) is electrically connected (wirelessly or in a wired manner) to the first wearable device 202, the power management module 360 may receive power from the other electronic device and charge the battery 370.

According to an embodiment of the disclosure, the battery 370 may supply power to at least one component of the first wearable device 202. According to an embodiment of the disclosure, the battery 370 may include, for example, a rechargeable battery. According to an embodiment of the disclosure, when the first wearable device 202 is placed in the case device 210, the first wearable device 202 may charge the battery 370 up to a predefined charge level and then turn on the first wearable device 202 or turn on at least a part of the communication circuit 320.

According to an embodiment of the disclosure, the interface 380 may support one or more predefined protocols that may be used for the first wearable device 202 to be directly connected (e.g., in a wired manner) to the electronic device 101, the case device 210, the second wearable device 204, or another electronic device. According to an embodiment of the disclosure, the interface 380 may include, for example, at least one of a high definition multimedia interface (HDMI), a USB interface, an SD card interface, a power line communication (PLC) interface, or an audio interface. According to an embodiment of the disclosure, the interface 380 may include at least one connection port to form a physical connection with the case device 210. According to an embodiment of the disclosure, the processor 310 may, for example, execute software to control at least one other component (e.g., a hardware component or a software component) of the first wearable device 202 connected to the processor 310 and may perform various data processing or computation. According to an embodiment of the disclosure, as at least a part of the data processing or computation, the processor 310 may load commands or data received from another component (e.g., the sensor 340 or the communication circuit 320) into the memory 390, process commands or data stored in the memory 390, and store result data in the memory 390. According to an embodiment of the disclosure, the processor 310 may determine whether an electrical connection is formed between the first wearable device 202 and the case device 210 through the sensor 340 or the interface 380. According to an embodiment of the disclosure, the processor 310 may, when an electrical connection is formed between the first wearable device 202 and the case device 210, receive location information of the second wearable device 204 from the case device 210. According to an embodiment of the disclosure, the processor 310 may identify whether a cover of the case device 210 is in an open state or a closed state by detecting a magnetic material provided in the case device 210 through a magnetic sensor included in the sensor 340. According to an embodiment of the disclosure, the processor 310 may determine whether an electrical connection is formed between the first wearable device 202 and the case device 210 by detecting that a connection port included in the interface 380 is in contact with an electrical contact of the case device 210. According to an embodiment of the disclosure, the processor 310 may establish a communication connection with the electronic device 101 through the communication circuit 320 and may receive data (e.g., audio data) from the electronic device 101 through the established communication connection. According to an embodiment of the disclosure, the processor 310 may transmit data received from the electronic device 101 to the second wearable device 204 through the communication circuit 320.

According to an embodiment of the disclosure, the second wearable device 204 configured as a pair with the first wearable device 202 may include components that are the same as or similar to those included in the first wearable device 202 and may perform all or part of operations of the first wearable device 202 described later with reference to the drawings.

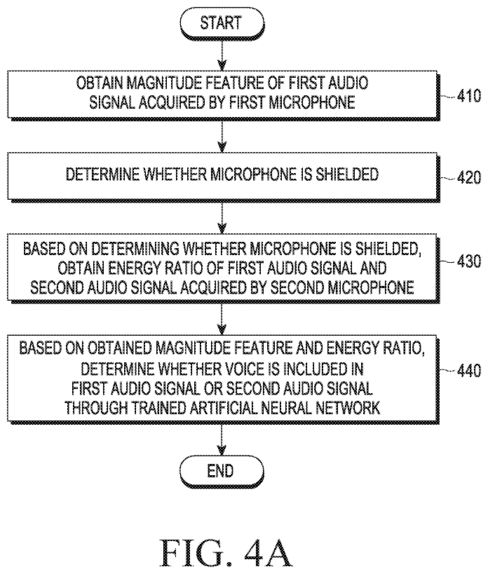

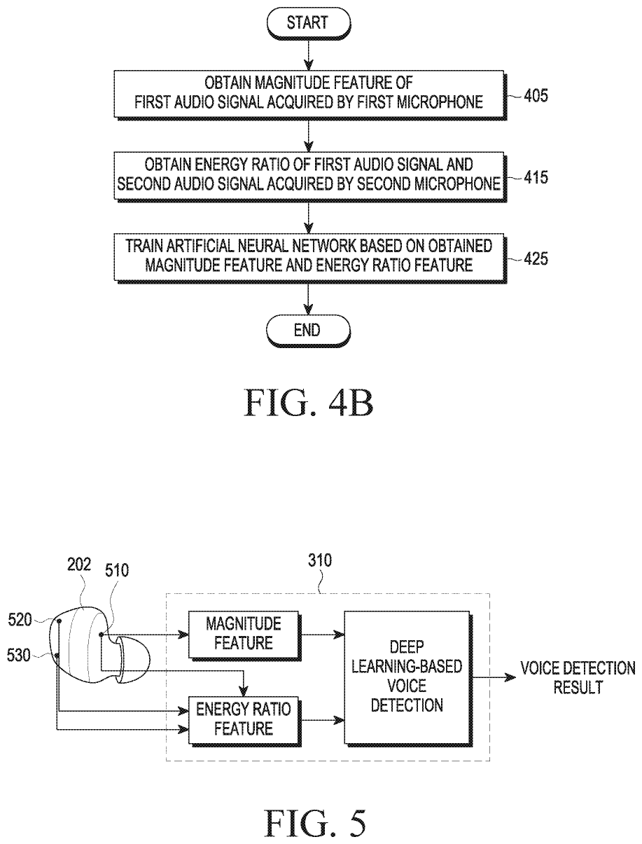

FIG. 4A is an example diagram for describing a function or operation in which a wearable device (e.g., the first wearable device 202) performs voice detection based on features of audio signals obtained through microphones (e.g., a first microphone 510, a second microphone 520, and/or a third microphone 530) of the wearable device (e.g., the first wearable device 202), according to an embodiment of the disclosure. FIG. 5 is an example diagram for describing a function or operation in which a wearable device (e.g., the first wearable device 202) performs voice detection through a trained artificial neural network based on magnitude features and energy ratio features of audio signals, according to an embodiment of the disclosure.

Referring to FIGS. 4A and 5, according to an embodiment of the disclosure, the wearable device 200 (e.g., the first wearable device 202) may, in operation 410, obtain a magnitude feature of a first audio signal obtained by the first microphone 510. According to an embodiment of the disclosure, the term “magnitude feature” may be alternatively or interchangeably referred to as an “energy spectrum.” According to an embodiment of the disclosure, the wearable device 200 may obtain signals in the frequency domain by performing a short-time Fourier transform on audio signals obtained by the first microphone 510, the second microphone 520, and/or the third microphone 530. According to an embodiment of the disclosure, the wearable device 200 may obtain the signals in the frequency domain using Equation 1 below.

Yᵢ(l,k)=STFT(yᵢ(n)),i∈{inner,outer₂,outer₃} [Equation 1]

In Equation 1, i may denote a microphone index, and STFT(⋅) may denote a short-time Fourier transform. In Equation 1, l∈{1, 2, . . . , L}, k∈{1, 2, . . . , K} may denote a frame index and a frequency index, respectively. According to an embodiment of the disclosure, the wearable device 200 may perform the short-time Fourier transform using a predetermined time interval (e.g., 20 ms).

According to an embodiment of the disclosure, the wearable device 200 may obtain a magnitude spectrum for a signal of the first microphone 510 (e.g., an internal microphone) among signals in the frequency domain converted according to Equation 1 using Equation 2 below. In the wearable device 200 in which a plurality of microphones are disposed, when the wearable device is worn by a user, an audio signal obtained by a microphone (e.g., the first microphone 510) disposed closer to a part of the user's body tends to have a higher signal-to-noise ratio. Accordingly, the wearable device 200 according to an embodiment of the disclosure may obtain (or compute) a magnitude spectrum for an audio signal obtained by the first microphone 510 among the plurality of microphones. According to an embodiment of the disclosure, in obtaining the magnitude spectrum, the wearable device 200 may obtain the magnitude spectrum for a predetermined frequency range (e.g., a frequency range of 4 kHz or less) in which a user's voice is likely to be mainly distributed. The predetermined frequency range according to an embodiment of the disclosure may be predefined (e.g., during manufacturing of the wearable device 200) or may be designated by a user. According to an embodiment of the disclosure, the wearable device 200 may store the obtained magnitude spectrum in the memory 390 at least temporarily as a magnitude feature.

|Yᵢₙₙₑᵣ(l,k)|,k∈{k_{lower},k_{lower}+1 . . . ,kᵤₚₚₑᵣ} [Equation 2]

In Equation 2, |Yᵢₙₙₑᵣ(l, k)| may denote a magnitude spectrum, and Yᵢₙₙₑᵣ(l, k) may denote a result obtained according to Equation 1, that is, a result obtained by a short-time Fourier transform. In Equation 2, by an absolute value symbol, a result obtained as a complex value may be converted into a real value. In Equation 2, k∈{k_{lower}, k_{lower}+1 . . . , kᵤₚₚₑᵣ} may denote a frequency bin index, and a smaller value of k may indicate a lower frequency. The magnitude spectrum obtained according to an embodiment of the disclosure may have a multi-dimensional value. According to an embodiment of the disclosure, in performing a voice detection function or operation, the wearable device 200 may use the magnitude spectrum obtained according to Equation 2, or may perform the voice detection function or operation using a power spectrum or a log power spectrum respectively obtained using Equation 3 and Equation 4 below.

|Yᵢₙₙₑᵣ(l,k)|² [Equation 3]

20 log₁₀|Yᵢₙₙₑᵣ(l,k)| [Equation 4]

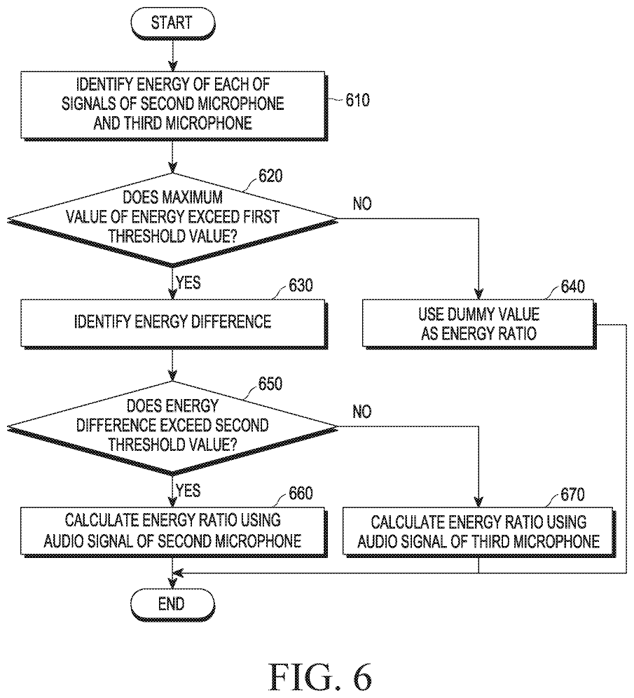

According to an embodiment of the disclosure, the wearable device 200 (e.g., the first wearable device 202) may, in operation 420, determine whether microphones (e.g., the second microphone 520 and the third microphone 530) are shielded. According to an embodiment of the disclosure, the wearable device 200 may determine whether the microphones (e.g., the second microphone 520 and the third microphone 530) are shielded based on an algorithm illustrated in FIG. 6. According to an embodiment of the disclosure, as described later, the wearable device 200 may obtain (e.g., determine or compute) an energy ratio feature based on whether the microphones are shielded.

FIG. 6 is an example diagram for describing a function or operation in which a wearable device 200 according to an embodiment of the disclosure computes an energy ratio based on whether microphones (e.g., the second microphone 520 and the third microphone 530) of the wearable device (e.g., the first wearable device 202) are shielded.

Referring to FIG. 6, according to an embodiment of the disclosure, the wearable device 200 may, in operation 610, identify energy of each of the signals of the second microphone 520 and the third microphone 530. According to an embodiment of the disclosure, the wearable device 200 may identify (e.g., obtain or calculate) the energy of each of the signals of the second microphone 520 and the third microphone 530 based on Equation 5 below.

Eᵢ(l)=α·Eᵢ(l)+(1−α)·Σₖ|Yᵢ(l,k)|²,i∈(inner,outer₂,outer₃) [Equation 5]

In Equation 5, Eᵢ(l) may denote energy of an audio signal obtained by a microphone, and α may be a constant.

According to an embodiment of the disclosure, the wearable device 200 may, in operation 620, determine whether a maximum value of the energy exceeds a first threshold value. For example, when the obtained energy value is 100 for the second microphone 520 and 0 for the third microphone 530 (e.g., when the second microphone 520 is in an open state and the third microphone 530 is in a shielded state), the wearable device 200 according to an embodiment of the disclosure may identify the maximum value of the energy as 100. In this case, for example, when the first threshold value is set to 50, the wearable device 200 according to an embodiment of the disclosure may determine that the maximum value of the energy exceeds the first threshold value.

According to an embodiment of the disclosure, when it is determined in operation 620 that a maximum value of the energy exceeds a first threshold value (e.g., operation 620—Yes), the wearable device 200 may, in operation 630, identify an energy difference. According to an embodiment of the disclosure, the wearable device 200 may, in operation 650, determine whether the energy difference identified in operation 630 exceeds a second threshold value. According to an embodiment of the disclosure, the wearable device 200 may calculate a difference between an energy value of an audio signal obtained by the third microphone 530 and an energy value of an audio signal obtained by the second microphone 520. For example, the wearable device 200 may, in operation 630, identify (e.g., determine or compute) the energy difference as −100. According to an embodiment of the disclosure, for example, when the second threshold value is set to 30, the wearable device 200 may, in operation 650, determine that the energy difference does not exceed the second threshold value.

According to an embodiment of the disclosure, when it is determined in operation 650 that the energy difference exceeds the second threshold value (operation 650—Yes), since both a first external microphone (e.g., the second microphone 520) and a second external microphone (e.g., the third microphone 530) are not shielded, the wearable device 200 may calculate an energy ratio using an audio signal obtained by the first external microphone (e.g., the second microphone 520). According to an embodiment of the disclosure, when it is determined in operation 650 that the energy difference does not exceed the second threshold value (operation 650—No), since the second external microphone (e.g., the third microphone 530) is shielded, the wearable device 200 may calculate an energy ratio using an audio signal obtained by the third microphone 530. According to an embodiment of the disclosure, the wearable device 200 may, through such an algorithm or process, determine which microphone among a plurality of external microphones is shielded by a part of a user's body or by another factor.

According to an embodiment of the disclosure, when a maximum value of the energy does not exceed the first threshold value in operation 640 (e.g., operation 620—No), since all external microphones are shielded, the wearable device 200 may use a dummy value as an energy ratio described later. Since the first microphone 510 is positioned closer to a part of a user's body (e.g., an ear) than the second microphone 520 and the third microphone 530 when the wearable device 200 is worn by the user, the first microphone 510 is less likely to be shielded by a part of the user's body. Accordingly, the wearable device 200 according to an embodiment of the disclosure may determine shielding only for the external microphones. However, according to an embodiment of the disclosure, the wearable device 200 may also determine whether the first microphone 510 is shielded. In this case, the wearable device 200 according to an embodiment of the disclosure may determine whether energy of an audio signal obtained by the first microphone 510 exceeds a threshold value and, based on the determination, determine whether the first microphone 510 is shielded. In this case, when the first microphone 510 is determined to be shielded, the wearable device 200 according to an embodiment of the disclosure may use a dummy value as an energy ratio described later.

Referring back to FIG. 4A, according to an embodiment of the disclosure, the wearable device 200 (e.g., the first wearable device 202) may, in operation 430, obtain an energy ratio of a first audio signal to a second audio signal obtained by the second microphone 520 based on a determination of whether shielding has occurred. According to an embodiment of the disclosure, the wearable device 200 may obtain (e.g., determine or compute) an energy ratio of an audio signal obtained by the first microphone 510 to an audio signal obtained by the second microphone 520 or the third microphone 530 using Equation 6 below. According to an embodiment of the disclosure, the wearable device 200 may store the obtained energy ratio in the memory 390 at least temporarily as an energy ratio feature.

$$Ratio ( l ) = \frac{{E}_{inner} ( l )}{{E}_{outer} ( l )} \qquad [ Equation 6 ]$$

In Equation 6, Eᵢₙₙₑᵣ(l) may denote energy of a first audio signal obtained by the first microphone. In Equation 6, Eₒᵤₜₑᵣ(l) may denote energy of a second audio signal obtained by an external microphone that is not shielded (e.g., the second microphone 520 or the third microphone 530). According to an embodiment of the disclosure, the energy ratio may include a one-dimensional value.

According to an embodiment of the disclosure, the wearable device 200 (e.g., the first wearable device 202) may, in operation 440, determine whether the first audio signal or the second audio signal includes a voice using a trained artificial neural network based on a magnitude feature obtained according to operation 410 and an energy ratio feature obtained according to operation 430. According to an embodiment of the disclosure, the wearable device 200 may use the magnitude feature obtained according to operation 410 and the energy ratio feature obtained according to operation 430 as input to the trained artificial neural network (e.g., a deep neural network (DNN)). According to an embodiment of the disclosure, the wearable device 200 may normalize, respectively, a magnitude feature obtained according to operation 410 and an energy ratio feature obtained according to operation 430 according to Equation 7 or Equation 8 below, and may use the normalized features as input values to a trained artificial neural network. The normalization according to Equation 7 below may denote min-max normalization, and the normalization according to Equation 8 may denote Z-score normalization.

$$\overline{X} = ( X - {X}_{min} ) / ( {X}_{max} - {X}_{min} ) \qquad [ Equation 7 ]$$

$$\overline{X} = \frac{X - {μ}_{X}}{{σ}_{X}} \qquad [ Equation 8 ]$$

In Equation 7, X may denote the obtained magnitude feature and energy ratio feature, and a normalization parameter Xₘₐₓ, Xₘᵢₙ, μ_{X}, σ_{X} may be predefined or may include a value personalized for a user. For example, when it is identified that a user is using the wearable device 200 in a low-noise environment (e.g., a state of a high signal-to-noise ratio), the wearable device 200 according to an embodiment of the disclosure may, for a period not exceeding a predetermined time (e.g., 5 seconds), identify the magnitude feature and the energy ratio feature, compute a personalized normalization parameter based thereon, and store the personalized normalization parameter in advance in the memory 390. For example, according to an embodiment of the disclosure, the wearable device 200 may determine maximum and minimum values of the magnitude features and the energy ratio features obtained over a predetermined time interval (e.g., 5 seconds) as, Xₘₐₓ, Xₘᵢₙ, respectively, and may store the determined values at least temporarily in the memory 390 as personalized normalization parameters. In addition, according to an embodiment of the disclosure, the wearable device 200 may determine a mean value and a standard deviation value of the magnitude features and the energy ratio features obtained over the predetermined time interval (e.g., 5 seconds) as μ_{X}, σ_{X}, respectively, and may store the determined values at least temporarily in the memory 390 as personalized normalization parameters.

According to an embodiment of the disclosure, the wearable device 200 may input normalized magnitude features and energy ratio features as input values to a trained artificial neural network. According to an embodiment of the disclosure, input values to the trained artificial neural network may be provided in units of frames defined by a short-time Fourier transform (e.g., frames defined by a time interval of 20 ms). Accordingly, the normalized magnitude features may be input to the artificial neural network as multi-dimensional values, and the normalized energy ratio features may be input to the artificial neural network as one-dimensional values. According to an embodiment of the disclosure, the artificial neural network may be trained according to an algorithm or process illustrated in FIG. 4B.

Referring to FIG. 4B, according to an embodiment of the disclosure, the wearable device 200 may, in operation 405, obtain a magnitude feature of a first audio signal obtained by the first microphone 510. According to an embodiment of the disclosure, the wearable device 200 may receive an audio signal prepared for training the artificial neural network. According to an embodiment of the disclosure, the wearable device 200 may obtain signals in a frequency domain by performing a short-time Fourier transform on audio signals obtained by the first microphone 510, the second microphone 520, and/or the third microphone 530. According to an embodiment of the disclosure, the wearable device 200 may obtain the signals in the frequency domain using Equation 1 described above. According to an embodiment of the disclosure, the wearable device 200 may obtain a magnitude feature of a first audio signal obtained by the first microphone 510 using Equation 2.

According to an embodiment of the disclosure, the wearable device 200 may, in operation 415, obtain an energy ratio of a first audio signal to a second audio signal obtained by the second microphone 520. According to an embodiment of the disclosure, the wearable device 200 may obtain the energy ratio using Equation 6 based on the second audio signal obtained by the second microphone 520. According to an embodiment of the disclosure, in a process of training an artificial neural network, a function or operation of determining whether microphones are shielded may be omitted.

According to an embodiment of the disclosure, the wearable device 200 may, in operation 425, perform training of an artificial neural network based on the obtained magnitude feature and the energy ratio feature. According to an embodiment of the disclosure, the wearable device 200 may use the magnitude feature obtained according to operation 405 and the energy ratio feature obtained according to operation 415 as input to a trained artificial neural network (e.g., a deep neural network (DNN)). According to an embodiment of the disclosure, the wearable device 200 may normalize, respectively, the magnitude feature obtained according to operation 405 and the energy ratio feature obtained according to operation 415 according to Equation 7 or Equation 8 described above, and may input the normalized features as input values to the trained artificial neural network. According to an embodiment of the disclosure, in a training stage of the artificial neural network, normalization may be performed by computing normalization parameters Xₘₐₓ, Xₘᵢₙ, μ_{X}, σ_{X} for training data. According to an embodiment of the disclosure, the wearable device 200 may output a value between 0 and 1 using normalized input features as input. According to an embodiment of the disclosure, in a training process of an artificial neural network, the wearable device 200 may update hyperparameters such that an output value matches a predefined deep learning target value. In this case, according to an embodiment of the disclosure, the wearable device 200 may use, as a loss function, a binary cross-entropy function or the like.

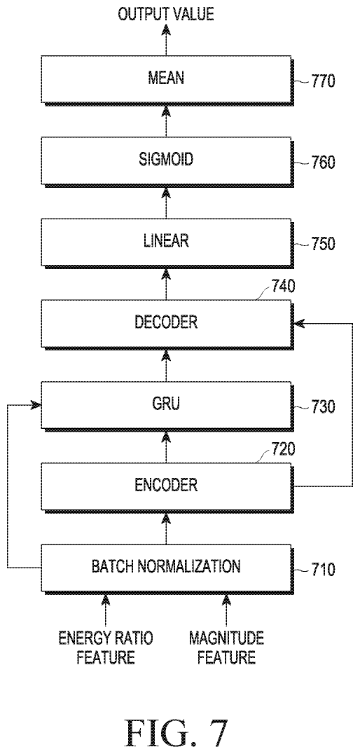

Referring back to FIG. 4A, according to an embodiment of the disclosure, the wearable device 200 may, in operation 440, determine whether a first audio signal or a second audio signal includes a voice using a trained artificial neural network based on the obtained magnitude feature and the energy ratio. According to an embodiment of the disclosure, the wearable device 200 may output a value between 0 and 1 using the trained artificial neural network illustrated in FIG. 7.

FIG. 7 is an example diagram for describing a function or operation in which the wearable device 200 processes magnitude features and energy ratio features input to a trained artificial neural network, according to an embodiment of the disclosure. Referring to FIG. 7, according to an embodiment of the disclosure, the artificial neural network may include at least one of a batch normalization module (or layer) 710, an encoder 720, a gated recurrent unit (GRU) 730, a decoder 740, a linear module 750, a sigmoid module 760, or an averaging module 770. According to an embodiment of the disclosure, the encoder 720 may include a plurality of convolution layers. According to an embodiment of the disclosure, the decoder 740 may include a plurality of transposed convolution layers. According to an embodiment of the disclosure, the wearable device 200 may perform batch normalization on magnitude features and energy ratio features using the batch normalization module 710. According to an embodiment of the disclosure, the wearable device 200 may encode batch-normalized magnitude features through the encoder 720. According to an embodiment of the disclosure, encoding may not be performed on batch-normalized energy ratio features. According to an embodiment of the disclosure, the encoded magnitude features may be input to the GRU 730. According to an embodiment of the disclosure, magnitude features that are not encoded may be input to the decoder 740 without passing through the GRU 730 (e.g., a skip connection operation). According to an embodiment of the disclosure, the skip connection operation may be omitted. According to an embodiment of the disclosure, the GRU 730 may identify a correlation between frames based on a time axis. According to an embodiment of the disclosure, the GRU 730 may identify a correlation between frames using information on a previous frame of an input frame stored in a wearable device (e.g., the memory 390). According to an embodiment of the disclosure, the GRU 730 may output, to the decoder 740, an output value in which the magnitude features and the energy ratio features are combined. According to an embodiment of the disclosure, the decoder 740 may decode an input value received from the GRU 730. According to an embodiment of the disclosure, the linear module 750 may convert a decoded high-dimensional result into a designated dimension (e.g., 64 dimensions). According to an embodiment of the disclosure, the sigmoid module 760 may map a value converted to the designated dimension to values between 0 and 1. According to an embodiment of the disclosure, the averaging module 770 may average the values mapped to values between 0 and 1 and output a value between 0 and 1. According to an embodiment of the disclosure, the wearable device 200 may determine whether at least one audio signal among obtained audio signals (e.g., a first audio signal or a second audio signal) includes a voice based on an output value. For example, according to an embodiment of the disclosure, the wearable device 200 may determine that a voice is present when the output value is greater than or equal to about 0.5. According to an embodiment of the disclosure, the wearable device 200 may determine that a voice is absent when the output value is less than about 0.5. According to an embodiment of the disclosure, the wearable device 200 may determine that a voice is present when the output value is greater than or equal to about 0.6. According to an embodiment of the disclosure, the wearable device 200 may determine that a voice is absent when the output value is less than about 0.4. According to an embodiment of the disclosure, the wearable device 200 may determine to withhold a determination when the output value is less than about 0.6 and greater than or equal to about 0.4. Such threshold values (e.g., about 0.5) may be adaptively determined according to a user environment (e.g., a noise level).

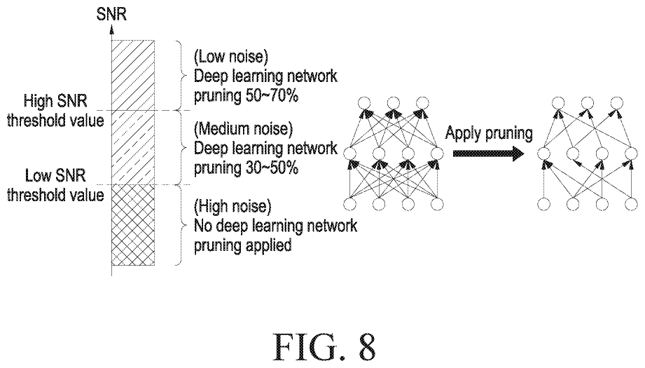

According to an embodiment of the disclosure, the wearable device 200 may apply a pruning algorithm or process based on a signal-to-noise ratio of an audio signal obtained by a microphone that is not shielded (e.g., the second microphone 520). FIG. 8 is an example diagram for describing a function or operation in which the wearable device 200 determines a computation ratio of a trained artificial neural network based on a signal-to-noise ratio of an audio signal input through a microphone of the wearable device 200, according to an embodiment of the disclosure. According to an embodiment of the disclosure, the wearable device 200 may perform 100% of network computation in a high-noise environment (e.g., a low signal-to-noise ratio). According to an embodiment of the disclosure, the wearable device 200 may perform 70% of network computation in a medium-noise environment (e.g., a moderate signal-to-noise ratio). According to an embodiment of the disclosure, the wearable device 200 may perform 50% of network computation in a low-noise environment (e.g., a high signal-to-noise ratio). According to an embodiment of the disclosure, pruned computations may not be performed. According to an embodiment of the disclosure, the wearable device 200 may apply a pruning algorithm to each layer or module (e.g., the encoder 720) and may exclude operations from computation in ascending order of weight values.

According to an embodiment of the disclosure, at least some of the various embodiments of the disclosure described above may be performed by an electronic device (e.g., the electronic device 101 of FIG. 1 or a server) operatively connected to the wearable device 200. For example, the wearable device 200 may transmit audio data to an electronic device (e.g., the electronic device 101 of FIG. 1 or a server), and voice detection may be implemented as a function or operation performed by the electronic device that receives the audio data.

According to an embodiment of the disclosure, a wearable device (e.g., the first wearable device 202) may include a first microphone 510, a second microphone 520 disposed at a position different from that of the first microphone 510, at least one processor 310, and a memory 390, and the memory 390 may store instructions that, when executed, cause the at least one processor 310 to obtain a magnitude feature of a first audio signal obtained by the first microphone 510, obtain an energy ratio of the first audio signal to a second audio signal obtained by the second microphone 520, and determine whether the first audio signal or the second audio signal includes a voice using a trained artificial neural network based on the obtained magnitude feature and the energy ratio.

According to an embodiment of the disclosure, the wearable device may further include a third microphone 530, and the instructions may further include instructions to determine whether the first microphone 510, the second microphone 520, and the third microphone 530 are shielded based on energy of audio data received by each of the first microphone 510, the second microphone 520, and the third microphone 530.

According to an embodiment of the disclosure, the instructions may further include instructions to obtain the energy ratio based on an audio signal obtained from a microphone that is not shielded based on a determination of whether shielding has occurred.

According to an embodiment of the disclosure, the instructions may further include instructions to perform a short-time Fourier transform on audio signals obtained by each of the first microphone 510, the second microphone 520, and the third microphone 530 in order to obtain the magnitude feature.

According to an embodiment of the disclosure, the instructions may further include instructions to determine a designated dummy value as the energy ratio when both the second microphone 520 and the third microphone 530 are shielded.

According to an embodiment of the disclosure, the instructions may further include instructions to determine a computation ratio of the trained artificial neural network based on a noise intensity of an audio signal obtained by the second microphone 520.

According to an embodiment of the disclosure, the instructions may further include instructions to obtain the energy ratio based on an audio signal of the second microphone 520 when both the second microphone 520 and the third microphone 530 are not shielded.

The electronic device according to various embodiments of the disclosure may be one of various types of devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of, the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “portion,” or “circuitry”. A module may be a single integral component, or a minimum unit or portion thereof, adapted to perform one or more functions. For example, according to an embodiment, the module may be implemented in a form of an application-specific integrated circuit (ASIC).

Various embodiments of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or further, a plurality of components (e.g., modules or programs) may be integrated into a single component. In such a case, according to an embodiment, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
a first microphone disposed at a first position;
a second microphone disposed at a second position different from the first position;
at least one processor and
memory storing instructions,
wherein the instructions, when executed by the at least one processor individually or collectively, cause the wearable device to:
obtain a magnitude feature of a first audio signal obtained by the first microphone,
obtain an energy ratio of the first audio signal to a second audio signal obtained by the second microphone, and
determine, using a trained artificial neural network, whether the first audio signal or the second audio signal includes a voice based on the magnitude feature and the energy ratio.

2. The wearable device of claim 1, wherein the wearable device further comprises a third microphone,
wherein the instructions, when executed by the at least one processor individually or collectively, cause the wearable device to determine whether the first microphone, the second microphone, and the third microphone are shielded based on energy of audio data received by each of the first microphone, the second microphone, and the third microphone.

3. The wearable device of claim 2, wherein the instructions, when executed by the at least one processor individually or collectively, cause the wearable device to, based on a result of determining whether the first microphone, the second microphone, and the third microphone are shielded, obtain the energy ratio based on an audio signal obtained from an unshielded microphone from among the first microphone, the second microphone, and the third microphone.

4. The wearable device of claim 2, wherein the instructions further include instructions to perform a short-time Fourier transform on audio signals obtained by each of the first microphone, the second microphone, and the third microphone to obtain the magnitude feature.

5. The wearable device of claim 2, wherein the instructions, when executed by the at least one processor individually or collectively, cause the wearable device to, based on determining that both the second microphone and the third microphone are shielded, determine a pre-designated dummy value as the energy ratio.

6. The wearable device of claim 1, wherein the instructions, when executed by the at least one processor individually or collectively, cause the wearable device to determine a computation ratio of the trained artificial neural network based on a noise intensity of an audio signal obtained by the second microphone.

7. The wearable device of claim 2, wherein the instructions, when executed by the at least one processor individually or collectively, cause the wearable device to, based on determining that both the second microphone and the third microphone are not shielded, obtain the energy ratio based on the second audio signal obtained by the second microphone.

8. A method comprising:
obtaining a magnitude feature of a first audio signal obtained by a first microphone of a wearable device;
obtaining an energy ratio of the first audio signal to a second audio signal obtained by a second microphone of the wearable device; and
determining, using a trained artificial neural network, whether the first audio signal or the second audio signal includes a voice based on the magnitude feature and the energy ratio.

9. The method of claim 8, further comprising:
determining whether the first microphone, the second microphone, and a third microphone of the wearable device are shielded based on energy of audio data received by each of the first microphone, the second microphone, and the third microphone.

10. The method of claim 9, wherein the obtaining the energy ratio comprises, based on a result of the determining whether the first microphone, the second microphone, and the third microphone are shielded, obtaining the energy ratio based on an audio signal obtained from an unshielded microphone from among the first microphone, the second microphone, and the third microphone.

11. The method of claim 9, wherein the obtaining the magnitude feature comprises obtaining the magnitude feature by performing a short-time Fourier transform on audio signals obtained by each of the first microphone, the second microphone, and the third microphone.

12. The method of claim 9, wherein the obtaining the energy ratio comprises, based on determining that both the second microphone and the third microphone are shielded, determining a pre-designated dummy value as the energy ratio.

13. The method of claim 8, further comprising determining a computation ratio of the trained artificial neural network based on a noise intensity of an audio signal obtained by the second microphone.

14. The method of claim 9, wherein the obtaining the energy ratio comprises, based on determining that both the second microphone and the third microphone are not shielded, obtaining the energy ratio based on the second audio signal obtained by the second microphone.

15. A non-transitory computer-readable recording medium storing instructions that, when executed by a processor of a wearable device, cause the wearable device to:
obtain a magnitude feature of a first audio signal obtained by a first microphone of a wearable device;
obtain an energy ratio of the first audio signal to a second audio signal obtained by a second microphone of the wearable device; and
determine, using a trained artificial neural network, whether the first audio signal or the second audio signal includes a voice based on the magnitude feature and the energy ratio.

16. The non-transitory computer-readable recording medium of claim 15, wherein the instructions, when executed by the processor of the wearable device, cause the wearable device to determine whether the first microphone, the second microphone, and a third microphone of the wearable device are shielded based on energy of audio data received by each of the first microphone, the second microphone, and the third microphone.

17. The non-transitory computer-readable recording medium of claim 16, wherein the instructions, when executed by the processor of the wearable device, cause the wearable device to, based on a result of determining whether the first microphone, the second microphone, and the third microphone are shielded, obtain the energy ratio based on an audio signal obtained from an unshielded microphone.

18. The non-transitory computer-readable recording medium claim 16, wherein the instructions, when executed by the processor of the wearable device, cause the wearable device to perform a short-time Fourier transform on audio signals obtained by each of the first microphone, the second microphone, and the third microphone to obtain the magnitude feature.

19. The non-transitory computer-readable recording medium of claim 16,
wherein the instructions, when executed by the processor of the wearable device, cause the wearable device to, based on determining that both the second microphone and the third microphone are shielded, determine a pre-designated dummy value as the energy ratio.

20. The non-transitory computer-readable recording medium of claim 15,
wherein the instructions, when executed by the processor of the wearable device, cause the wearable device to determine a computation ratio of the trained artificial neural network based on a noise intensity of an audio signal obtained by the second microphone.
